(19) United States
(12) Patent Application Publication
(10) Pub. No.: US 2025/0172091 A1
(43) Pub. Date: May 29, 2025

(54) SYSTEM FOR PURGING A FUEL HAVING REACTIVE GAS

(71) Applicant: GE Infrastructure Technology LLC, Greenville, SC (US)

(72) Inventor: Pierre MONTAGNE, Belfort (FR)

(21) Appl. No.: 19/036,602

(22) Filed: Jan. 24, 2025

Related U.S. Application Data
(62) Division of application No. 17/924,324, filed on Nov. 9, 2022.

(30) Foreign Application Priority Data
May 14, 2020 (FR) 2004746

(51) Int. Cl. F02C 7/22; F02C 9/52; F23R 3/28

(52) U.S. Cl. CPC F02C 7/222; F02C 9/52; F23R 3/28

(57) ABSTRACT

This system for purging a fuel containing hydrogen comprises a gas turbine. The gas turbine comprises at least one combustion chamber (20) provided with at least one injector (52) of the fuel, an exhaust section and a hot gas circuit going from the combustion chamber (20) to the exhaust section. The system comprises at least one point of injection (A, A′) of air and/or of inert gas positioned on the hot gas circuit.

The present invention relates to a system for purging a fuel, in particular based on reactive gas, such as hydrogen (more specifically molecular hydrogen), used to feed a gas turbine.

The invention belongs to the field of combustion systems and in particular gas turbines comprising combustion chambers and hot air passages for combustion gases.

A gas turbine is generally composed mainly of an air compression section comprising one or more compression stages.

Most of the compressed air is mixed with the gaseous or liquid fuel injected through the injectors into at least one combustion chamber in order to be incinerated. Typically, the combustion systems are of annular type or of the type comprising several combustion chambers, in communication with the air originating from the compressor.

The flow of hot gases which are generated in the combustion subsequently passes through hot gas cavities up to an expansion turbine comprising one or more expansion stages before being discharged to an exhaust section or a recovery boiler. The passage through the turbine section brings about the rotation, thus making it possible to recover the mechanical energy in the rotor. A part of the rotational energy is used to rotate the rotor section of the compressor and the alternator. Due to the extreme temperatures, the speed of the hot gases and the speed of the rotor, it is necessary to mitigate the thermal stresses by the internal cooling of the blades.

The expansion turbine is composed of at least one row or one stage of blades fitted in fixed fashion with respect to the rotor. It is known that the blades are hollow, so that the cavity of these blades makes it possible to create an internal cooling circuit which makes it possible to send compressed air originating from the compressor to the fixed blades. Each of these blades comprises an aerodynamic profile with a side subjected to the pressure of the flow and a suction side which are connected by trailing edges.

The document U.S. Pat. No. 5,491,970 describes combustion chambers which make it possible to reduce the emissions of nitrogen oxide or carbon monoxide, comprising injectors for a fuel oil/air mixture, for a low-load combustion mode (diffusion mode) or a full-load combustion mode (premix mode).

The document US-A-2018 187893 also describes a combustion chamber, comprising several combustion stages, a primary combustion zone or primary section and a secondary combustion zone or secondary section, which is arranged axially in the direction of the combustion gas flow downstream of the primary section. The secondary section comprises an additional inlet for an air/fuel oil mixture.

The document US-A-2015 096306 describes the compressor section and the turbine section of a gas turbine, comprising rows of moving blades fitted to the rotor of the turbine, spaced apart and separated by fixed blades fitted to the stator, it being possible for all of these blades to be cooled.

Furthermore, the use of a mixture of gaseous fuels, such as natural gas, which can comprise a reactive gas fraction, such as hydrogen, exhibits a number of advantages, in particular a richer mixture and the reduction in the carbon dioxide emissions. For example, a mixture of fuels with 30% hydrogen makes possible the reduction of 10% in the carbon dioxide emissions.

In particular, during the starting of a turbine following a false start, with a fuel or mixture of fuels which can contain a percentage of hydrogen which can range up to 100% or containing a reactive gas fraction, such as hydrogen, it is necessary to carry out an operation of purging the fuel feed pipe, and also in the cavities of the turbine section, in order to drive off the non-incinerated fuel. This is because the fraction of hydrogen in the fuel can form an air/fuel mixture which can have a lower minimum ignition energy than natural gas and can easily ignite.

Thus, in the case of a false start, the stagnant air/fuel mixture passing through the combustion system and downstream of the latter exhibits a high risk of accumulation and of explosion, and the deflagration can damage items of equipment located downstream of the expansion section, such as exhaust pipes, indeed even the recovery boiler in the case of a combined cycle.

In particular, when the hydrogen is at ambient pressure and at ambient temperature, its ignition range in air is between 4% and 75% and its minimum ignition energy varies as a function of the concentration of hydrogen and of oxygen and also of the stoichiometry of the mixture (for each hydrogen molecule, there is half an oxygen molecule). On the other hand, the self-ignition temperature from which the hydrogen spontaneously ignites is approximately 585° C./858K and is thus higher than that of the majority of the other flammable gases.

The ignition of a reactive gas cloud can create a sudden release of energy resulting in the propagation of a flame front and a blast wave. The theoretical conditions for explosion of hydrogen in air will essentially depend on its concentration in the fuel, for example a concentration ranging from 4% to 8%, while deflagration will be achieved from 8% and detonation can, in some cases, occur from 11%.

However, the use of a hydrogen fraction presents important challenges in design for the adaptation of the items of equipment. This is in particular the case when the gas mixture is confined in the cavities of the turbine downstream of the combustion, due to its high ability to diffuse in air, in particular when it is being forced by the compressed air originating from the compression section.

Thus, in the case of use of hydrogen in a mixture of fuels for the starting of a gas turbine, the following points are to be considered:
limiting the energy accumulated in a gas volume downstream of the combustion and in particular in the exhaust,
   modifying the lower heating value (LHV) and the higher heating value (HHV) of the mixture,
   extricating from the flammability range,
   increasing the self-ignition temperature,
   strengthening the resistance of the items of equipment to an explosion.

In order to reduce the risks associated with the presence of an explosive gas volume in the cavities of the turbine, several approaches have been proposed, namely:
the taking into account, during the design of the items of equipment, of the energy released during a possible deflagration,
the dilution of the hydrogen downstream of the combustion with air or an inert gas or a combustion-inhibiting gas,
the decrease in the amount of fuel during starting,
the lighting of the flame at a rate which makes possible the purging of the gas by an increase in the flow of air and in the flushing of the cavities of the turbine.

The simplest and most economical approach consists in diluting the hydrogen mixture with air or an inert gas, in order to modify the LHV and the HHV of the mixture. However, this solution requires means for the injection of inert gas into the hot gas cavities and passages downstream of the combustion.

The objective of the invention is to make possible the dilution of a reactive mixture of fuels, for example containing a hydrogen fraction, so as to modify the LHV and the HHV of the mixture and to purge the reactive fuel possibly present in the hot gas circuit of a gas turbine, in particular in the case of a false start, without having to create passages for an additional flow of air or of inert gas.

With this aim, the present invention provides a system for purging a reactive fuel containing hydrogen, comprising a gas turbine, the gas turbine comprising at least one combustion chamber provided with at least one injector of the fuel, an exhaust section and a hot gas circuit, going from the combustion chamber to the exhaust section through an expansion turbine, noteworthy in that it comprises at least one point of injection of air and/or of inert gas and/or of combustion inhibitor positioned on the hot gas circuit.

Thus, the solution provided makes it possible to add, in the cavities of the combustion chamber and downstream of the latter, a purging system using an additional flow of air and/or of inert gas and/or of combustion inhibitor. In particular, the invention seeks to create a flow of air and/or of inert gas and/or of combustion inhibitor under optimum conditions, in order to provide at most the dilution of the reactive gas fraction, such as hydrogen, in the mixture. This dilution can be provided by the distribution and/or the location of the injection point(s) on the hot gas circuit.

At least two sections for injection of air and/or of inert gas and/or of combustion inhibitor can be considered: an injection downstream of the flame, in order to avoid disruptions in the combustion, and an injection at the inlet of the exhaust section at the outlet of the expansion turbine. Preferably, in order to improve the effectiveness of the the dilution, the two injections should be carried out in reversed flows.

Thus, in a specific embodiment, the at least one injection point is located downstream of the at least one injector of the fuel, preferably an injection downstream of the flame zone.

In this specific embodiment, the at least one injection point can be located at the inlet of the exhaust section.

In another specific embodiment, in which the expansion turbine additionally comprises a cooling circuit having fixed blades which is located on the hot gas circuit, the at least one injection point is located on this cooling circuit.

In another specific embodiment, the purging system additionally comprises a distribution ring placed inside an exhaust downstream of the exhaust section, the at least one injection point being located on the distribution ring.

In all these specific embodiments, the at least one injection point of the purging system can be connected to an external feed source.

The inert gas used by the purging system can be nitrogen or carbon dioxide or steam.

The combustion-inhibiting gas used by the purging system can be bromomethane, tetrachloromethane or a halogen hydrocarbon, indeed even a hydrofluorocarbon.

In another embodiment, said at least one injection point can comprise a mixture of: air, inert gas, combustion-inhibiting gas.

The dilution of the combustible mixture with air or with an inert gas, such as carbon dioxide, nitrogen or steam, can make it possible to modify or to lower the lower explosive level (LEL), to minimize the volume of inert gas to be used and to improve the economics of the process.

On the other hand, if it is desired to treat the problem of detonation (because it is possible to have a risk of accumulation with a nonhomogeneous dilution), it is preferable to combine the use of air and of an inert gas, in order for the inert gas to be used to suppress the detonating nature of a combustible mixture, while the use of a combustion inhibitor can make it possible to halt the propagation of a possible deflagration detonation.

The system can comprise several injection points positioned at different places on the hot gas circuit.

### BRIEF DESCRIPTION OF THE DRAWINGS

Other aspects and advantages of the invention will become apparent on reading the detailed description below of specific embodiments, given by way of examples which are in no way limiting, with reference to the appended drawings, in which:

FIG. 1 is a graph representing detonation and flammability curves for a combustible mixture of air and of hydrogen as a function of an added percentage of inert gas in a specific embodiment of the purging system in accordance with the invention where the inert gas added is nitrogen.

FIG. 2 is a graph representing detonation and flammability curves for a combustible mixture of air and of hydrogen as a function of an added percentage of inert gas in a specific embodiment of the purging system in accordance with the invention where the inert gas added is carbon dioxide.

FIG. 3 is a diagrammatic view in longitudinal section of a conventional gas

turbine with its main components and the hot gas circuit.

FIG. 4 is a diagrammatic view of a detailed description of the hot gas passages in the expansion turbine.

FIG. 5 is a diagrammatic view illustrating a first embodiment of the invention.

FIG. 6 is a diagrammatic view illustrating a second embodiment of the invention.

FIG. 7 is a diagrammatic view illustrating a third embodiment of the invention.

### DESCRIPTION OF EMBODIMENT(S)

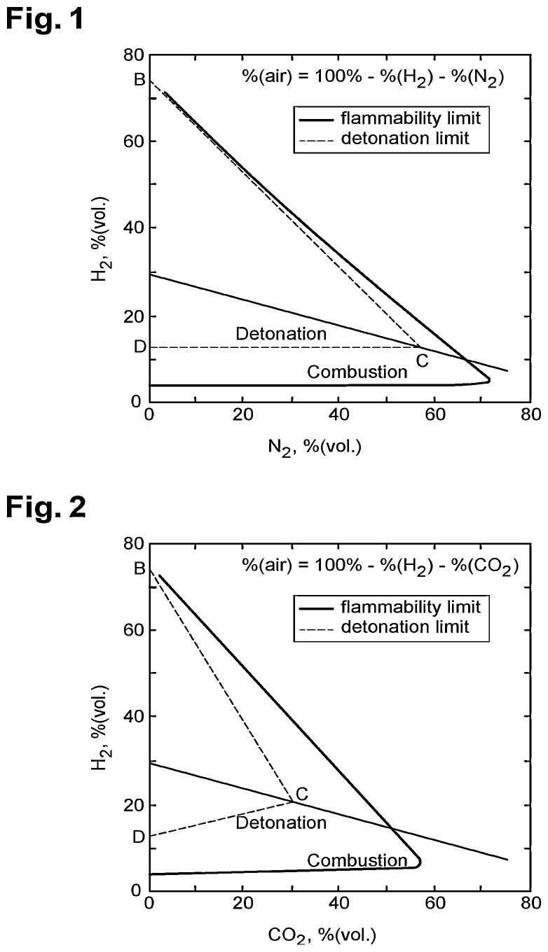

In the graph of FIG. 1, the axis of the abscissae is the percentage by volume of nitrogen added in a combustible mixture of air and of hydrogen, the percentage by volume of hydrogen of which is shown on the axis of the ordinates.

The curve as continuous lines represents the limits of the flammability zone and the curve in dashes represents the limit of the detonation zone.

At point D, the combustible mixture comprises 30% by volume of hydrogen and 70% by volume of air. It is seen, at point C, that it is possible to exit from the detonation zone if the hydrogen concentration is reduced to 13% by volume, by the addition of 58% by volume of nitrogen, in which case the mixture comprises 29% by volume of air.

In the graph of FIG. 2, the axis of the abscissae is the percentage by volume of carbon dioxide added in a combustible mixture of air and of hydrogen, the percentage by volume of hydrogen of which is shown on the axis of the ordinates.

The curve as continuous lines represents the limit of the flammability zone and the curve in dashes represents the limit of the detonation zone.

At point D, the combustible mixture comprises 30% by volume of hydrogen and 70% by volume of air. It is seen, at point C, that it is possible to exit from the detonation zone if the hydrogen concentration is reduced to 13% by volume, by the addition of 30% by volume of carbon dioxide, in which case the mixture comprises 57% by volume of air.

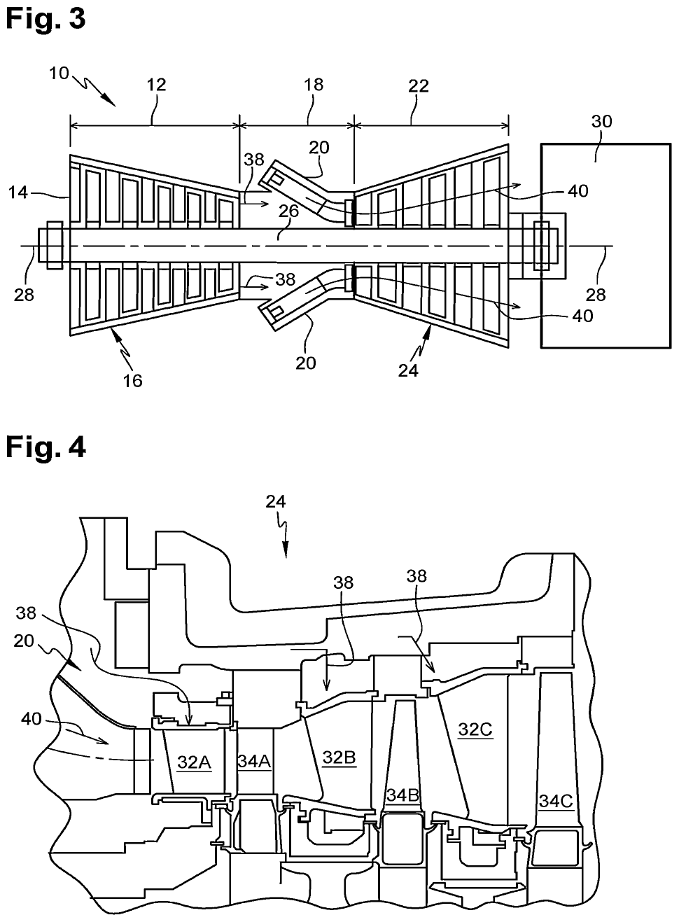

FIG. 3 diagrammatically represents a view in longitudinal section of a conventional gas turbine 10. The main components of the gas turbine 10 are as follows: a compression section 12 comprising a compressor 16, an air inlet 14 and a compressed air outlet 38; a section of the combustion system 18, from where combustion gas streams, known as hot gases, 40 escape; an expansion section or turbine 22 comprising fixed blades and moving blades fitted to a rotor 26 of axis of rotation 28, the rotor 26 connecting the compression section 12, the expansion turbine 22 and one or more combustion chambers 20, the flow of hot gases 40 traversing the stages of the expansion turbine 24 (in the expansion section 22) up to the inlet of an exhaust section 30.

FIG. 4 shows a detailed description of the upper part of the expansion turbine 24 traversed by the hot gases 40. Stages of blades 32A, 32B and 32C are fixed to the stator, while moving blades 34A, 34B and 34C are fixed to the rotor 26 illustrated in FIG. 3. Thus, a passage and cavities for hot gases exiting from the combustion chamber 20 illustrated in FIG. 3 are formed upstream of the exhaust section 30 illustrated in FIG. 3.

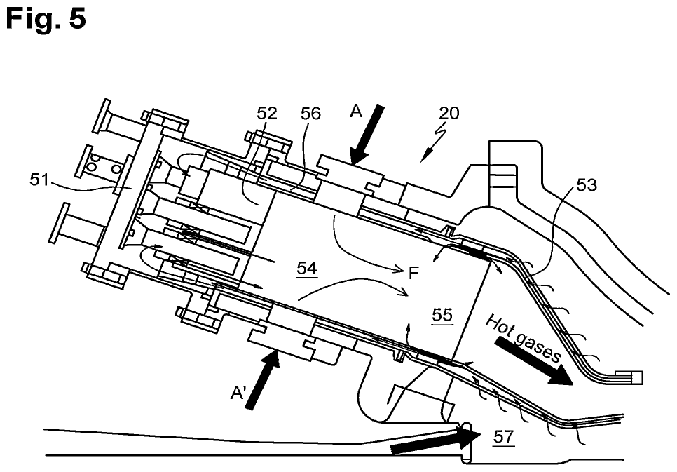

FIG. 5 illustrates a first embodiment of the invention, where the purging system comprises a point of injection “A and A” of air and/or of inert gas and/or of combustion inhibitor into the combustion system, preferably downstream of the flame or combustion zone in the combustion chamber.

A fuel containing a predetermined part of hydrogen is considered.

The purging system in accordance with the invention comprises a gas turbine of the type of the gas turbine 10 described above with reference to FIG. 3. In particular, the gas turbine 10 comprises at least one combustion chamber 20 provided with at least one injector 52 of the abovementioned fuel. The gas turbine 10 also comprises an exhaust section 30 (see FIG. 3) and a hot gas circuit 40 going from the combustion chamber 20 to the exhaust section 30.

The combustion chamber 20 illustrated in FIG. 5 is typically limited, on the one hand, at the inlet, by a cover 51 where inlet connections for fuel injectors 52 are found and, on the other hand, at the outlet, by a transition piece 53 emerging toward the stages of the expansion turbine 24 (not represented in FIG. 5 but visible in FIG. 3).

Inside the combustion chamber 20, a liner 56 makes possible the passage of compressed air 57 originating from the compressor 16 (illustrated in FIG. 3) to the intake of the fuel injectors 52. Inside the combustion chamber 20, a combustion zone 54 and a dilution zone 55 can be formed in operation.

The references A and A′ denote, in this first embodiment, at least one point of injection of air and/or of inert gas and/or of combustion inhibitor. This injection point is on the hot gas circuit, immediately downstream of the zone where the flame is supposed to be, in the case of lighting on starting. The injection points A and A′ are thus located downstream of the fuel injectors 52.

In the specific embodiment of FIG. 5, the injection points A and A′ are located at the combustion zone 54. Thus, as the gas turbine is equipped with a controller (not represented), the latter makes possible the opening of the valve for controlling the reactive gas flow making possible the starting of the combustion system. At the same time as this starting, the controller also provides for the purging system to be active, either before or at the same time, for an injection of air and/or of inert gas creating a flow F which mixes with the hydrogen-based fuel which is in the combustion chamber 20 and in the hot gas circuit of the turbine.

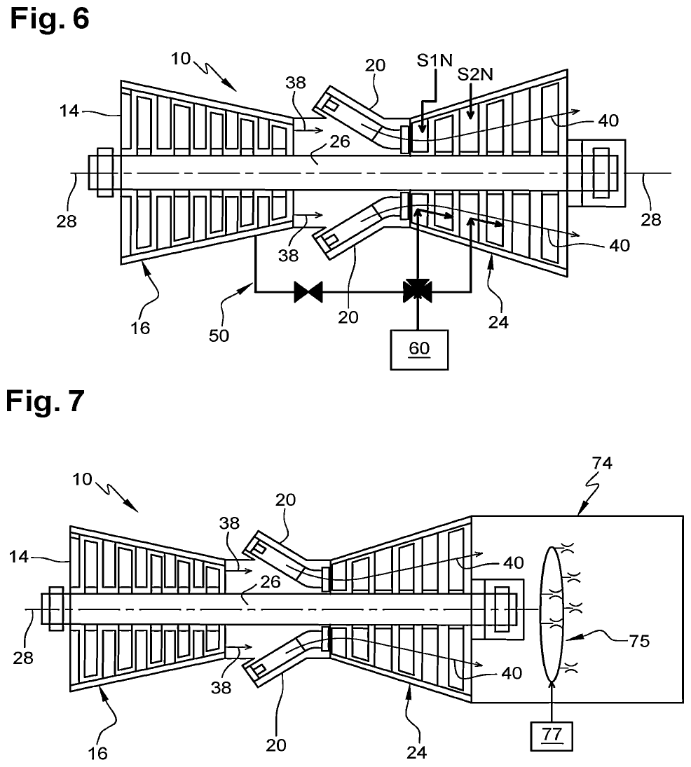

FIG. 6 illustrates a second embodiment of the invention, in which the gas turbine comprises a cooling circuit having fixed blades. In this second embodiment, the injection of air and/or of inert gas can be carried out through the cooling circuit. It is sufficient for this to have available at least one point of injection of air and/or of inert gas on the cooling circuit 50.

The cooling circuit 50 comprises a plurality of fixed blades, including those denoted by the references S1N and S2N in FIG. 6. These blades are fixed to the stator at the hot gas passage and cavities 40. Furthermore, the source to be injected into the cooling circuit can be air withdrawn from the compressor 16 or an external source 60 of air and/or of inert gas and/or of combustion inhibitor.

FIG. 7 illustrates a third embodiment of the invention, in which the gas turbine comprises a distribution ring 75 placed inside the exhaust section 74 located immediately downstream of the expansion turbine 24. In this third embodiment, the injection of air and/or of inert gas and/or of combustion inhibitor can be carried out through the distribution ring 75. For this, it is sufficient to have available at least one injection point on the distribution ring 75. Furthermore, the source to be injected into the distribution ring 75 can be an external source 77 of air and/or of inert gas and/or of combustion inhibitor.

In all the embodiments described above, as nonlimiting examples, the inert gas used for the purging can be nitrogen or carbon dioxide or also steam.

Of course, in all the embodiments described above, the volume and the flow of air and/or of inert gas and/or of combustion inhibitor chosen to be injected depend on the hydrogen fraction in the fuel and on the volume of fuel injected for false starting, or also on the volume in the hot gas circuit of the turbine.

Furthermore, the three embodiments described can be combined in order to provide an effective solution making it possible to mix the air and/or the inert gas with the fuel comprising a hydrogen fraction.

1-8. (canceled)

9. A method for purging a fuel containing hydrogen from a hot gas circuit of a gas turbine, the method comprising:
providing a fuel containing hydrogen to a combustion zone of the gas turbine;
injecting one of an inert gas or a combustion-inhibiting gas downstream of the combustion zone;
modifying the lower heating value (LHV) and the higher heating value (HHV) of the fuel containing hydrogen; and
extricating from a flammability range.

10. The method as in claim 9, further comprising exiting a detonation zone by:
reducing a hydrogen concentration in the fuel containing hydrogen to 13% by volume by the addition of one of:
58% by volume of nitrogen; or
30% by volume of carbon dioxide.

11. The method as in claim 9, wherein the method includes diluting the fuel containing hydrogen to modify the lower heating value (LHV) and the higher heating value (HHV) of the fuel containing hydrogen.

12. The method as in claim 9, wherein the method includes injecting the inert gas downstream of the combustion zone, and wherein said inert gas is nitrogen.

13. The method as in claim 9, wherein the method includes injecting the inert gas downstream of the combustion zone, wherein said inert gas is carbon dioxide.

14. The method as in claim 9, wherein the method includes injecting the inert gas downstream of the combustion zone, wherein said inert gas is steam.

15. The method as in claim 9, wherein the method includes injecting the combustion-inhibiting gas downstream of the combustion zone, wherein the combustion-inhibiting gas is bromomethane.

16. The method as in claim 9, wherein the method includes injecting the combustion-inhibiting gas downstream of the combustion zone, wherein the combustion-inhibiting gas is tetrachloromethane.

17. The method as in claim 9, wherein the method includes injecting the combustion-inhibiting gas downstream of the combustion zone, wherein the combustion-inhibiting gas is a halogen hydrocarbon.
